(19) United States
(12) Patent Application Publication
(10) Pub. No.: US 2025/0329307 A1
(43) Pub. Date: Oct. 23, 2025

(54) Liquid Crystal Display with extended overdrive duration and Driving Method Thereof

(71) Applicant: QISDA CORPORATION, Taoyuan City (TW)

(72) Inventor: Chun-Chang Wu, Taoyuan City (TW)

(73) Assignee: QISDA CORPORATION, Taoyuan City (TW)

(21) Appl. No.: 19/014,181

(22) Filed: Jan. 8, 2025

(30) Foreign Application Priority Data
Apr. 19, 2024 (CN) 202410473144.2

(51) Int. Cl. G09G 3/36

(52) U.S. Cl. CPC G09G 3/3607; G09G 2320/0252; G09G 2320/0271; G09G 2320/0285

(57) ABSTRACT

A driving method of a liquid crystal display includes generating an output grayscale value of a pixel of an output frame according to N input grayscale values of the pixels of Y input frames, and displaying the pixel of the output frame according to at least the output grayscale value of the pixel of the output frame. N and Y are positive integers and N is greater than or equal to Y.

### BACKGROUND OF THE INVENTION

### 1. Field of the Invention

The present invention is related to liquid crystal display (LCD), and in particular, to a liquid crystal display with extended overdrive duration and a driving method thereof.

### 2. Description of the Prior Art

When liquid crystal displays (LCDs) display dynamic images, the image may suffer from motion blur due to the pixel response time of the LCD. Therefore, LCDs usually use overdrive (OD) technology to improve image quality. In the prior art, the overdrive lookup table (OD LUT) is checked according to the grayscale of the pixel of the previous input frame and the grayscale of the pixel of the current input frame to adjust the grayscale of the pixel of the current output frame. However, through this method, the driving effect only occurs within one frame period. As the panel control IC improves, the frame rate becomes faster and faster. The response time of liquid crystal pixels limited by the flipping speed is already longer than one frame period, resulting in insufficient OD duration and slower pixel response time in the prior art.

### SUMMARY OF THE INVENTION

According to an embodiment of the invention, a driving method of a liquid crystal display includes generating an output grayscale value of a pixel of an output frame according to N input grayscale values of the pixels of Y input frames, and displaying the pixel of the output frame according to at least the output grayscale value of the pixel of the output frame. N and Y are positive integers and N is greater than or equal to Y.

According to another embodiment of the invention, a liquid crystal display includes a processor and a display unit. The processor is configured to generate an output grayscale value of a pixel of an output frame according to N input grayscale values of the pixels of Y input frames. The display unit is coupled to the processor, and is configured to display the pixel of the output frame according to at least the output grayscale value of the pixel of the output frame. N and Y are positive integers and N is greater than or equal to Y.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a liquid crystal display according to an embodiment of the present invention.

FIG. 2 is a flow chart of a driving method of the liquid crystal display in FIG. 1.

FIG. 3 is a schematic diagram of a driving method of a liquid crystal display according to an embodiment of the present invention.

FIG. 4 is a schematic diagram of a driving method of a liquid crystal display according to another embodiment of the present invention.

FIG. 5 is a schematic diagram of a driving method of a liquid crystal display according to another embodiment of the present invention.

FIG. 6 is a block diagram of a liquid crystal display according to another embodiment of the present invention.

FIG. 7 is a flow chart of a driving method of the liquid crystal display in FIG. 6.

FIG. 8 is a schematic diagram of an actual output end grayscale value.

FIG. 9 is a flow chart of another driving method of the liquid crystal display in FIG. 6.

### DETAILED DESCRIPTION

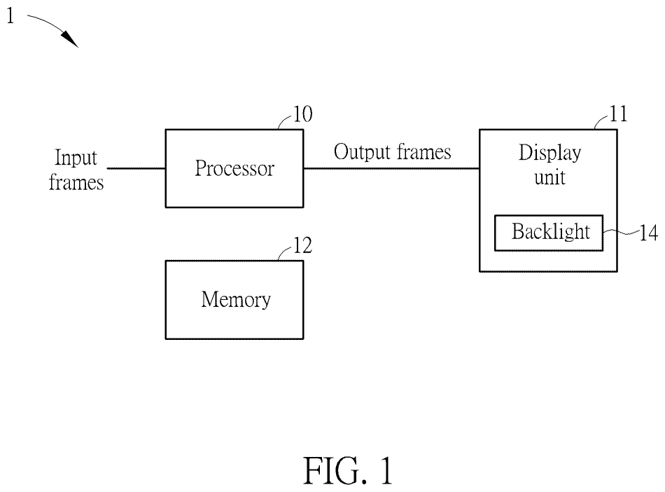

The present invention provides a driving method for a liquid crystal display, which adjusts the pixel grayscale value of the current output frame according to the pixel grayscale values of a plurality of input frames, so that the overdrive (OD) duration may be a plurality of frame periods. FIG. 1 is a block diagram of a liquid crystal display 1 according to an embodiment of the present invention. The liquid crystal display 1 may include a processor 10, a display unit 11 and a memory 12. The processor 10 may be an image processor, the display unit 11 may be a liquid crystal display including a pixel array, the display unit 11 may include a backlight 14, and the memory 12 may be a non-volatile memory. The memory 12 is coupled to the processor 10 and is configured to store a lookup table. The processor 10 receives the input frame data and the lookup table to generate output frame data, the input frame data includes the input grayscale values of the pixels of the input frames, and the output frame data includes the output grayscale values of the pixels of the output frames. The input grayscale values and the output grayscale values may be different to achieve OD and speed up the response time. The display unit 11 is coupled to the processor 10 and is configured to receive the output frame data from the processor 10 and display the output frames according to the output frame data.

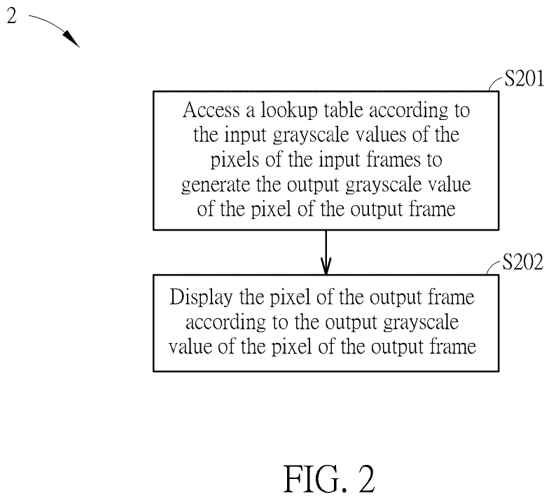

FIG. 2 is a flow chart of a driving method 2 of the liquid crystal display 1 in FIG. 1. The driving method 2 of the liquid crystal display 1 comprises Steps S201 to S202. Any reasonable step change or adjustment is within the scope of the disclosure. Steps S201 to S202 are explained as follows:
Step S201: Access a lookup table according to the input grayscale values of the pixels of the input frames to generate the output grayscale value of the pixel of the output frame;
Step S202: Display the pixel of the output frame according to the output grayscale value of the pixel of the output frame.

In Step S201, the processor 10 accesses the lookup table stored in the memory 12 according to the N input grayscale values of the pixels of the Y input frames to obtain the output grayscale value of the pixel of the output frame. The input frames are frames whose pixel values have been obtained before step S201, and the output frame is a frame whose pixel value needs to be obtained according to the input frames' information for output. N and Y are positive integers, N is greater than 2 and N is greater than or equal to Y. There may be M lookup tables stored in the memory 12, and N>M>0. The pixels of the Y input frames and the pixel of the output frame may be R pixels, G pixels, or B pixels, where the pixels of the Y input frames and the pixel of the output frame are the same type of pixel. For example, the pixels of Y input frames and the pixel of the output frame are all R pixels. By obtaining the pixel grayscale value of the current output frame according to the pixel grayscale values of a plurality of input frames, the OD duration may be extended to a plurality of frame periods, thus solving the problem of insufficient OD duration. A frame period is the time required to display an output frame.

In Step S202, the display unit 11 displays the pixel of the output frame according to the output grayscale value of the pixel of the output frame. Furthermore, in order to avoid motion blur during the liquid crystal flipping process, the backlight of the LCD may be turned on when the output frame is displayed and may be turned off during part of the output frame period. When the backlight is turned off, the time point at which the backlight is switched to on will be later than the output start time of the current output frame.

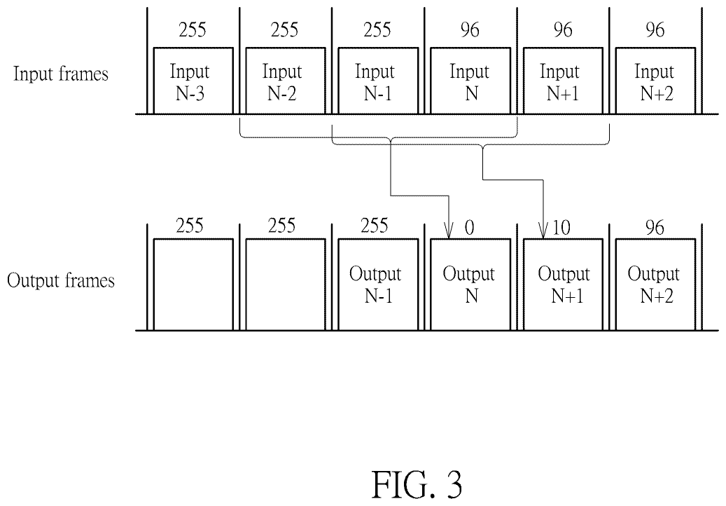

FIG. 3 is a schematic diagram of a driving method 2 of a liquid crystal display 1 according to an embodiment of the present invention. When Y=N, the processor 10 may access M N-dimensional lookup tables stored in the memory 12 according to the N input grayscale values of the pixels of a current input frame and the previous Y−1 input frames to generate the output grayscale value of the pixel of the output frame. The Y input frames are consecutive frames and Y>2.

In FIG. 3, Y=N=3, M=1. To generate the current output frame Output N, access a 3-dimensional lookup table stored in the memory 12 according to three input grayscale values from the pixels of the current input frame Input N and the previous two input frames Input N−1 and Input N−2. The contents of the lookup table may be found in Table 1.

TABLE 1

| Row number | Input N-2 | Input N-1 | Input N | Output N |
|---|---|---|---|---|
| 0 | 0 | 0 | 0 | 0 |
| 1 | 0 | 0 | 32 | 53 |
| 2 | 0 | 0 | 64 | 117 |
| . . . | | | | |
| R2 | 255 | 96 | 96 | 10 |
| . . . | | | | |
| R1 | 255 | 255 | 96 | 0 |

Table 1 is the lookup table in the embodiment of FIG. 3. As shown in Table 1, by accessing Table 1 according to the input grayscale values of the pixels of the input frames Input N−2, Input N−1 and Input N, the output grayscale value of the pixel of the output frame Output N may be obtained. Taking FIG. 3 as an example, the input grayscale values of the pixels of the input frames Input N−2, Input N−1 and Input N are 255, 255 and 96 respectively. It can be known from row R1 in Table 1 that when the input grayscale values of the pixels of the input frames Input N−2, Input N−1 and Input N are 255, 255 and 96 respectively, the output grayscale value of the pixel of the output frame Output N is 0. In similar way, if the current output frame to be generated is the output frame Output N+1 in FIG. 3, access Table 1 according to the input grayscale values of the pixels of the input frames Input N−1, Input N and Input N+1. In FIG. 3, the input grayscale values of the pixels of the input frames Input N−1, Input N and Input N+1 are 255, 96 and 96 respectively. It can be known from row R2 in Table 1 that when the input grayscale values of the pixels of the input frames Input N−1, Input N and Input N+1 are 255, 96 and 96 respectively, the output grayscale value of the pixel of the output frame Output N+1 is 10. The output grayscale values of the pixels in other output frames may be obtained by accessing in a similar way, and will not be described again here.

The above embodiment takes Y=N=3 as an example. However, in some embodiments, Y and N may be other positive integers greater than 2. That is, accessing lookup table according to the input grayscale values of the pixels of more than two input frames to obtain the output grayscale value of the pixel of the output frame.

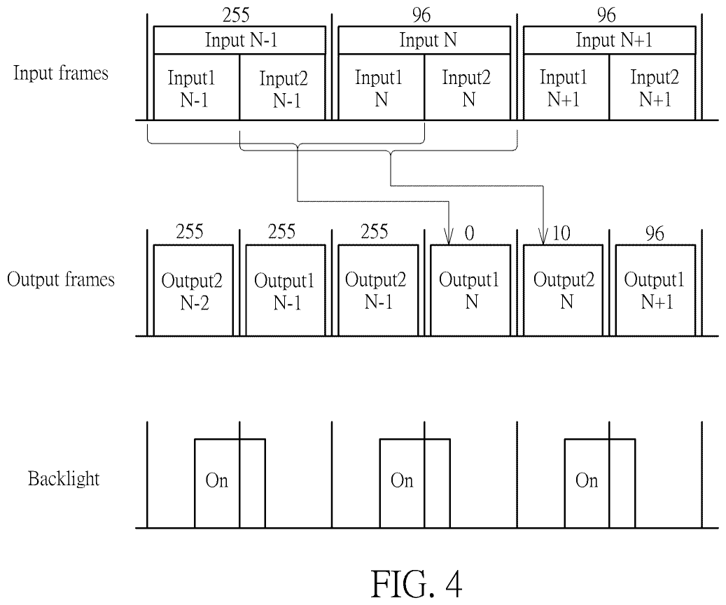

FIG. 4 is a schematic diagram of a driving method of a liquid crystal display according to another embodiment of the present invention. When the frequency of the output frames is X times the frequency of the input frames, N being greater than Y, since the frequency of the input frames is smaller than the frequency of the output frames, each of the Y input frames may be regarded as X sub frames. The input grayscale value of each sub frame of each input frame is the same as the input grayscale value of the each input frame. The processor 10 generates the output grayscale value of the pixel of the output frame according to the N input grayscale values of the pixels from an [(X−1)+ (N−1)]th sub frame prior to the current sub frame to an (X−1)th sub frame prior to the current sub frame.

The Y input frames are continuous frames and the X sub frames are continuous sub frames. X is greater than or equal to 2. By treating each of the Y input frames as X sub frames, the panel's high refresh rate may be more effectively utilized. If the input frame is not regarded as a plurality of sub frames, excessive overdrive my lead to overshoot. If the input frame is regarded as a plurality of sub frames, stronger OD may be applied in the previous sub frames, so that the pixel grayscale of the output frame may be reached more quickly, resulting in a faster response time.

In FIG. 4, Y=2, N=3, M=1, X=2, the frequency of the output frames is twice the frequency of the input frames. In FIG. 4, each input frame may be regarded as two sub frames, and the sub frames from the same input frame have the same input grayscale value. For example, Input N in FIG. 4 may be regarded as two sub frames Input1 N and Input2 N, and Input1 N and Input2 N have the same input grayscale value (=96). To generate the output grayscale value of the pixel of the output frame Output N, the processor 10 may access a 3-dimensional lookup table stored in the memory 12 according to the three input grayscale values of the pixels from the 3rd sub frame prior to a current sub frame to the 1st sub frame prior to the current sub frame. The Y input frames are continuous frames and the 2 sub frames are continuous sub frames. The contents of the lookup table may be found in Table 1.

Taking FIG. 4 as an example, the input frame Input N−1 may be regarded as two sub frames Input1 N−1 and Input2 N−1, the input frame Input N may be regarded as two sub frames Input1 N and Input2 N, and the input frame Input N+1 may be regarded as two sub frames Input1 N+1 and Input2 N+1. To generate the output grayscale value of the pixel of the output frame Output1 N, Table 1 may be accessed according to the input grayscale values of the pixels from the 3rd sub frame (Input1 N−1) prior to a current sub frame (Input2 N) to the 1st sub frame (Input1 N) prior to the current sub frame (Input2 N). That is, access Table 1 according to the input grayscale values of the pixels of the sub frames Input1 N−1, Input2 N−1, and Input1 N to obtain the output frame Output1 N. As shown in FIG. 4, the input grayscale values of the pixels of the sub frames Input1 N−1, Input2 N−1 and Input1 N are 255, 255 and 96 respectively. It can be known from row R1 in Table 1 that when the input grayscale values of the pixels of the three sub frames are 255, 255 and 96 respectively, the output grayscale value of the pixel of the output frame Output1 N is 0.

Similarly, to generate the output grayscale value of the pixel of the output frame Output2 N in FIG. 4, Table 1 may be accessed according to the input grayscale values of the pixels of the sub frames Input2 N−1, Input1 N, and Input2 N. The input grayscale values of the pixels of the sub frames Input2 N−1, Input1 N, and Input2 N are 255, 96 and 96 respectively. It can be known from row R2 in Table 1 that when the input grayscale values of the pixels of the three sub frames are 255, 96 and 96 respectively, the output grayscale value of the pixel of the output frame Output2 N is 10. The output grayscale values of the pixels in other output frames may be obtained by accessing in a similar way, and will not be described again here.

The display unit 11 displays the pixel of the output frame according to the output grayscale value of the pixel of the output frame. The backlight of the LCD may be turned on when the output frame is displayed and may be turned off during part of the output frame period. As shown in FIG. 4, the backlight is turned on at output frame Output2 N−1 and turned off at output frame Output1 N. When the backlight is turned off, the time point at which the backlight is switched to on will be later than the output start time of the current output frame. The delay of the backlight relative to the output frame and the cycle time of the backlight may be adjusted depending on the requirements such as position and clarity

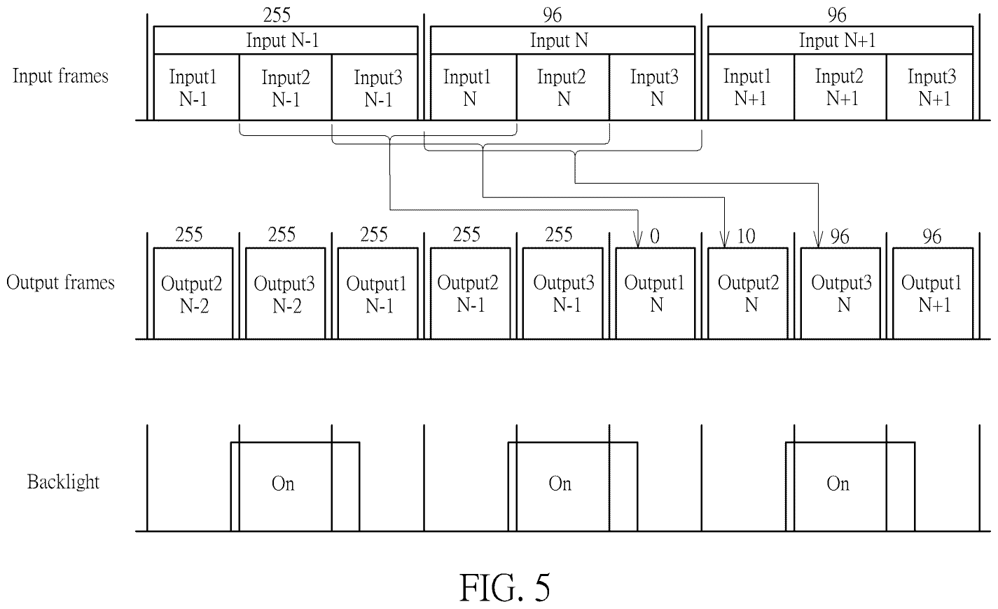

The above embodiment takes Y=2, N=3, and X=2 as an example. However, in some embodiments, X may be other positive integers greater than 2, such as 3. FIG. 5 is a schematic diagram of a driving method of a liquid crystal display according to another embodiment of the present invention. In FIG. 5, Y=2, N=3, X=3. The processor 10 may access a lookup table according to the input grayscale values of the pixels from the 4th sub frame prior to a current sub frame to the 2nd sub frame prior to the current sub frame to obtain the output grayscale value of the pixel in the output frame. The access method in the embodiment in FIG. 5 is similar to the embodiment in FIG. 4, and will not be described again here. In some embodiments, Y and N may be different values.

The display unit 11 displays the pixel of the output frame according to the output grayscale value of the pixel of the output frame. The backlight of the LCD may be turned on when the output frame is displayed and may be turned off during part of the output frame period. As shown in FIG. 5, the backlight is turned on at output frame Output2 N−1 and turned off at output frame Output1 N. When the backlight is turned off, the time point at which the backlight is switched to on will be later than the output start time of the output frame Output2 N−1. The delay of the backlight relative to the output frame and the cycle time of the backlight may be adjusted depending on the requirements such as position and clarity

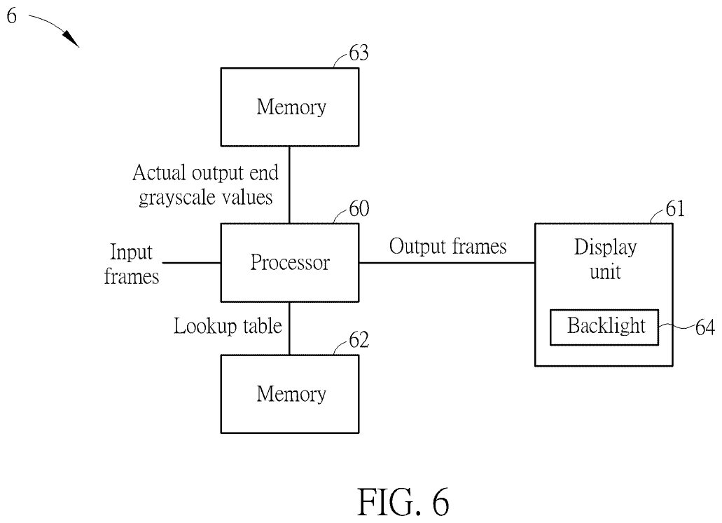

FIG. 6 is a block diagram of a liquid crystal display 6 according to another embodiment of the present invention. The liquid crystal display 6 may include a processor 60, a display unit 61, a memory 62 and a memory 63. The processor 60 may be an image processor, the display unit 61 may be a liquid crystal display including a pixel array, and the display unit 61 includes a backlight 64. The memories 62 and 63 may be non-volatile memories. The memory 62 may be coupled to the processor 60 for storing the lookup table. The memory 63 may be coupled to the processor 60 for storing actual output end grayscale values. The processor 60 may receive input frame data, a lookup table, and actual output end grayscale values to generate output frame data. The input frame data includes the input grayscale values of the pixels of the input frames, and the output frame data includes the output grayscale values of the pixels of the output frames. The display unit 61 may be coupled to the processor 60 and configured to receive the output frame data from the processor 60 and display the output frame according to the output frame data. In some embodiments, the memories 62 and 63 may be implemented by the same non-volatile memory. In other embodiments, the memories 62 and 63 may be implemented by separate non-volatile memories.

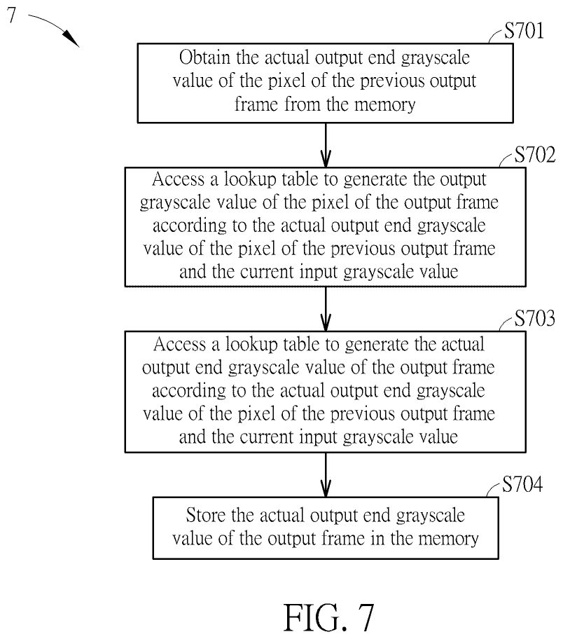

FIG. 7 is a flow chart of a driving method 7 of the liquid crystal display 6 in FIG. 6. The driving method 7 of the liquid crystal display 6 comprises Steps S701 to S704. Any reasonable step change or adjustment is within the scope of the disclosure. Steps S701 to S704 are explained as follows:
Step S701: Obtain the actual output end grayscale value of the pixel of the previous output frame from the memory;
Step S702: Access a lookup table to generate the output grayscale value of the pixel of the output frame according to the actual output end grayscale value of the pixel of the previous output frame and the current input grayscale value;
Step S703: Access a lookup table to generate the actual output end grayscale value of the output frame according to the actual output end grayscale value of the pixel of the previous output frame and the current input grayscale value;
Step S704: Store the actual output end grayscale value of the output frame in the memory.

The actual output end grayscale value of the pixel of the previous output frame may be stored in the memory 63. In Step S701, the processor 60 obtains the actual output end grayscale value of the pixel of the previous output frame from the memory 63. Then in Step S702, the processor 60 may access a 2-dimensional end grayscale overdrive lookup table to generate the output grayscale value of the pixel of the output frame according to the actual output end grayscale value of the pixel of the previous output frame and the input grayscale value of the pixel of the current input frame. Then the display unit displays the pixel of the output frame according to the output grayscale value of the pixel of the output frame. The pixels of the input frames and the pixels of the output frames may be R pixels, G pixels, or B pixels, where the pixels of the input frames and the pixels of the output frames are the same type of pixels. The contents of the end grayscale overdrive lookup table may be found in Table 2.

TABLE 2

| End grayscale | | Input N | | | | |
|---|---|---|---|---|---|---|
| overdrive lookup table | | 0 | 32 | 64 | 96 | 128 |
| End N-1 | . . . | | | | | |
| | 160 | 0 | 0 | 0 | 10 | 85 |
| | 192 | 0 | 0 | 0 | 0 | 36 |
| | 224 | 0 | 0 | 0 | 0 | 0 |
| | 255 | 0 | 0 | 0 | 0 | 0 |

Table 2 is the end grayscale overdrive lookup table in the embodiment of FIG. 7. As shown in Table 2, by accessing end grayscale overdrive lookup table according to the actual output end grayscale value of the pixel of the previous output frame End N−1 and the input grayscale value of the current input frame Input N, the output grayscale value of the pixel of the output frame Output N may be obtained. For example, if the actual output end grayscale value of the pixel of the previous output frame End N−1 is 255 and the input grayscale value of the current input frame Input N is 96, it can be known from Table 2 that when the actual output end grayscale value of the pixel of the previous output frame End N−1 is 255 and the input grayscale value of the current input frame Input N is 96, the output grayscale value of the pixel of the output frame Output N is 0.

In Step S703, the processor 60 may access a 2-dimensional end grayscale input lookup table to generate the actual output end grayscale value of the pixel of the output frame according to the actual output end grayscale value of the pixel of the previous output frame and the input grayscale value of the current frame. The contents of the end grayscale input lookup table may be found in Table 3.

TABLE 3

| | |
|---|---|
| End grayscale | Input N |

| | | | | | |
|---|---|---|---|---|---|
| input lookup table | 0 | 32 | 64 | 96 | 128 |

| | | | | | | |
|---|---|---|---|---|---|---|
| End N-1 | . . . | | | | | |
| | 160 | 96 | 96 | 96 | 96 | 128 |
| | 192 | 112 | 112 | 112 | 112 | 128 |
| | 224 | 128 | 128 | 128 | 128 | 128 |
| | 255 | 160 | 160 | 160 | 160 | 160 |

Table 3 is the end grayscale input lookup table in the embodiment of FIG. 7. As shown in Table 3, by accessing end grayscale input lookup table according to the actual output end grayscale value of the pixel of the previous output frame End N−1 and the input grayscale value of the current input frame Input N, the actual output end grayscale value of the pixel of the output frame End N may be obtained. For example, if the actual output end grayscale value of the pixel of the previous output frame End N−1 is 255 and the input grayscale value of the current input frame Input N is 96, it can be known from Table 3 that when the actual output end grayscale value of the pixel of the previous output frame End N−1 is 255 and the input grayscale value of the current input frame Input N is 96, the actual output end grayscale value of the pixel of the output frame End N is 160.

In Step S704, after obtaining the actual output end grayscale value of the pixel of the output frame, store the actual output end grayscale value of the pixel of the output frame in the memory 63 for access when obtaining the output grayscale value of the pixel of the next output frame and the actual output end grayscale value of the next output frame. For example, the processor 60 may access the end grayscale overdrive lookup table to obtain the output grayscale value of the pixel of the next output frame Output N+1 according to the actual output end grayscale value of the pixel of the output frame End N and the input grayscale value of the next input frame Input N+1, and may access the end grayscale input lookup table to obtain the actual output end grayscale value of the pixel of the next output frame End N+1 according to the actual output end grayscale value of the pixel of the output frame End N and the input grayscale value of the next input frame Input N+1.

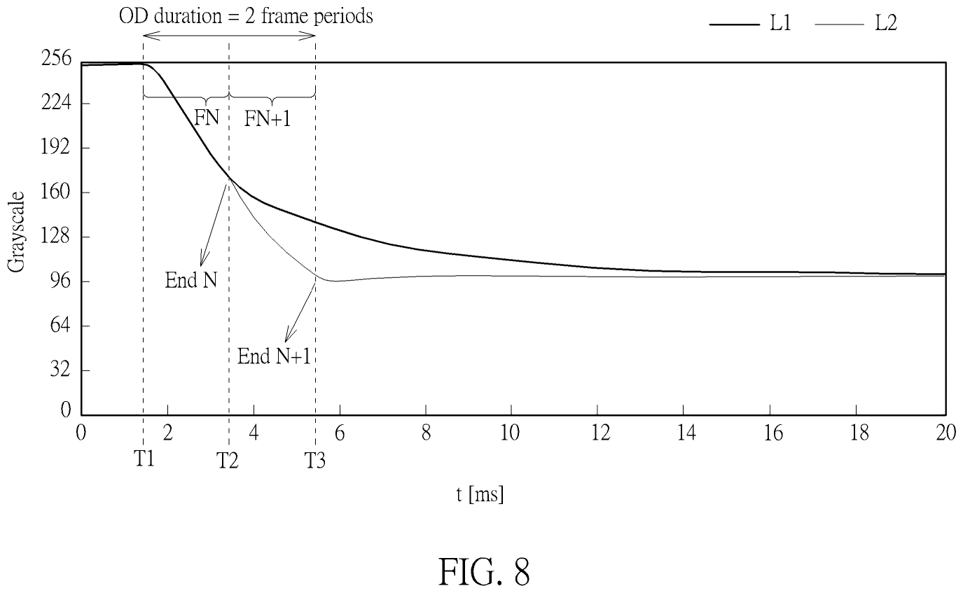

FIG. 8 is a schematic diagram of an actual output end grayscale value, the horizontal axis represents the time t in milliseconds (ms), and the vertical axis represents the grayscale. FN and FN+1 are the Nth frame and N+1th frame respectively. The output grayscale value of a pixel in the output frame is the target grayscale value to be output obtained by accessing the lookup table, and the actual output end grayscale value is the actual grayscale value at the end of the frame. As shown in FIG. 8, the actual output end grayscale value End N is the end grayscale value of the Nth frame FN in FIG. 8, which is the actual grayscale value at time T2. The actual output end grayscale value End N+1 is the end grayscale value of the N+1th frame FN+1 in FIG. 8, which is the actual grayscale value at time T3. As shown in FIG. 8, the actual output end grayscale value at time T1 may be 255. At time T2, the actual output end grayscale value may be 160. At time T3, the actual output end grayscale value may be 96. In prior art, it was assumed the value at the end of the frame reaches the output grayscale value of the pixel of the output frame. However, due to the high refresh rate, the values at the end of the frame may not reach the output grayscale value of the pixel of the output frame within one frame period. By considering the actual output end grayscale value End N, the output grayscale value of the pixel in the next output frame may be adjusted according to the information of the actual output end grayscale value, so that the OD duration may be extended to a plurality of frame periods, thereby solving the problem of insufficient OD duration. A frame period is the time required to display an output frame. As shown in FIG. 8, a frame period is 2 ms. The line L1 represents a case where the OD duration is one frame period, while the line L2 represents another case where the OD duration is two frame periods. As shown in FIG. 8, at time T3, the actual output end grayscale value of the line L2 is smaller than the actual output end grayscale value of the line L1, which indicates that the line L2 can reach the target grayscale value faster than the line L1.

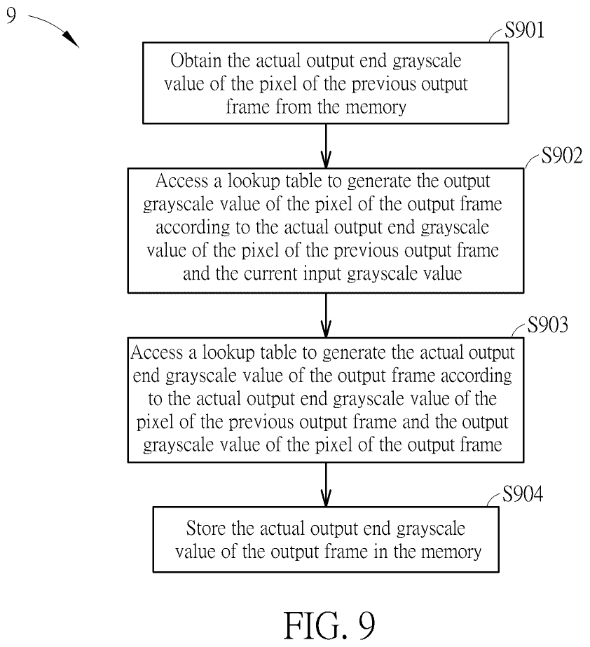

FIG. 9 is a flow chart of another driving method 9 of the liquid crystal display 6 in FIG. 6. The driving method 9 of the liquid crystal display 6 comprises Steps S901 to S904. Any reasonable step change or adjustment is within the scope of the disclosure. Steps S901 to S904 are explained as follows:
Step S901: Obtain the actual output end grayscale value of the pixel of the previous output frame from the memory;
Step S902: Access a lookup table to generate the output grayscale value of the pixel of the output frame according to the actual output end grayscale value of the pixel of the previous output frame and the current input grayscale value;
Step S903: Access a lookup table to generate the actual output end grayscale value of the output frame according to the actual output end grayscale value of the pixel of the previous output frame and the output grayscale value of the pixel of the output frame;
Step S904: Store the actual output end grayscale value of the output frame in the memory.

Step S901, Step S902 and Step S904 are similar to Step S701, step S702 and Step S704 respectively, and will not be described again here.

In Step S903, the processor 60 access a 2-dimensional end grayscale output lookup table to generate the actual output end grayscale value of the output frame according to the actual output end grayscale value of the pixel of the previous output frame and the output grayscale value of the pixel of the output frame generated in Step S902. The contents of the end grayscale output lookup table may be found in Table 4.

TABLE 4

| End grayscale | | Output N | | | | |
|---|---|---|---|---|---|---|
| output lookup table | | 0 | 32 | 64 | 96 | 128 |
| End N-1 | . . . | | | | | |
| | 160 | 96 | 105 | 119 | 133 | 146 |
| | 192 | 112 | 126 | 139 | 152 | 165 |
| | 224 | 128 | 146 | 162 | 173 | 184 |
| | 255 | 160 | 166 | 192 | 207 | 221 |

Table 4 is the end grayscale output lookup table in the embodiment of FIG. 9. As shown in Table 4, by accessing end grayscale output lookup table according to the actual output end grayscale value of the pixel of the previous output frame End N−1 and the output grayscale value of the pixel of the output frame Output N, the actual output end grayscale value of the pixel of the output frame End N may be obtained. For example, if the actual output end grayscale value of the pixel of the previous output frame End N−1 is 255 and the output grayscale value of the pixel of the output frame Output N generated in Step S902 is 0, it can be known from Table 4 that when the actual output end grayscale value of the pixel of the previous output frame End N−1 is 255 and the output grayscale value of the pixel of the output frame Output N is 0, the actual output end grayscale value of the pixel of the output frame End N is 160.

The driving method 9 of the liquid crystal display generates the actual output end grayscale value of the pixel of the output frame according to the output grayscale value of the pixel of the output frame, and the output grayscale value of the pixel of the output frame already includes the influence of the end grayscale overdrive lookup table. Therefore, for different end grayscale overdrive lookup tables, the end grayscale output lookup table may have the same content, which may further reduce the amount of data in the lookup table.

The lookup table, the end grayscale overdrive lookup table, the end grayscale input lookup table and the end grayscale output lookup table are all stored in the memory 62.

The driving method of a liquid crystal display of the present invention obtains the pixel grayscale value of the current output frame according to the pixel grayscale values of a plurality of input frames. Through this method, the OD duration may be extended to a plurality of frame periods, thus solving the problem of insufficient OD duration.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method of a liquid crystal display comprising:
generating an output grayscale value of a pixel of an output frame according to N input grayscale values of the pixels of Y input frames; and
displaying the pixel of the output frame according to at least the output grayscale value of the pixel of the output frame;
wherein N and Y are positive integers, and N is greater than or equal to Y.

2. The method of claim 1, wherein generating the output grayscale value of the pixel of the output frame according to the N input grayscale values of the pixels of the Y input frames is accessing a lookup table according to the N input grayscale values of the pixels of the Y input frames to obtain the output grayscale value of the pixel of the output frame.

3. The method of claim 1, wherein generating the output grayscale value of the pixel of the output frame according to the N input grayscale values of the pixels of the Y input frames comprises, when Y=N:
generating the output grayscale value of the pixel of the output frame according to the N input grayscale values of the pixels from a current input frame and previous Y−1 input frames;
wherein the Y input frames are consecutive frames; and
Y>2.

4. The method of claim 1, wherein generating the output grayscale value of the pixel of the output frame according to the N input grayscale values of the pixels of the Y input frames comprises, when N>Y, and a frequency of the output frames is X times a frequency of the Y input frames:
each of the Y input frames comprises X sub frames, wherein an input grayscale value of each sub frame of each input frame is the same as an input grayscale value of the each input frame;
generating the output grayscale value of the pixel of the output frame according to the N input grayscale values of the pixels from an [(X−1)+ (N−1)]th sub frame prior to a current sub frame to an (X−1)th sub frame prior to the current sub frame;
wherein the Y input frames are continuous frames, and the X sub frames are continuous sub frames; and
X is greater than or equal to 2.

5. The method of claim 1, wherein generating the output grayscale value of the pixel of the output frame according to the N input grayscale values of the pixels of the Y input frames comprises, when Y=2, N=3 and a frequency of the output frames is 2 times a frequency of the Y input frames:
each of the Y input frames comprises 2 sub frames, wherein an input grayscale value of each sub frame of each input frame is the same as an input grayscale value of the each input frame;
generating the output grayscale value of the pixel of the output frame according to the N input grayscale values of the pixels from a 3rd sub frame prior to a current sub frame to a previous sub frame of the current sub frame;
wherein the Y input frames are continuous frames, and the 2 sub frames are continuous sub frames.

6. The method of claim 1, wherein generating the output grayscale value of the pixel of the output frame according to the N input grayscale values of the pixels of the Y input frames comprises, when Y=2, N=3 and a frequency of the output frames is 3 times a frequency of the Y input frames:
each of the Y input frames comprises 3 sub frames, wherein an input grayscale value of each sub frame of each input frame is the same as an input grayscale value of the each input frame;
generating the output grayscale value of the pixel of the output frame according to the N input grayscale values of the pixels from a 4th sub frame prior to a current sub frame to a 2nd sub frame prior to the current sub frame;
wherein the Y input frames are continuous frames, and the 3 sub frames are continuous sub frames.

7. The method of claim 1, wherein generating the output grayscale value of the pixel of the output frame according to the N input grayscale values of the pixels of the Y input frames comprises:
accessing an end grayscale overdrive lookup table to generate the output grayscale value of the pixel of the output frame according to an actual output end grayscale value of a pixel of a previous output frame and a current input grayscale value.

8. The method of claim 7, wherein displaying the pixel of the output frame according to at least the output grayscale value of the pixel of the output frame comprises:
accessing an end grayscale input lookup table to generate an actual output end grayscale value of the output frame according to the actual output end grayscale value of the pixel of the previous output frame and the current input grayscale value; and
storing the actual output end grayscale value of the output frame in a memory.

9. The method of claim 7, wherein displaying the pixel of the output frame according to at least the output grayscale value of the pixel of the output frame comprises:
accessing an end grayscale output lookup table to generate an actual output end grayscale value of the output frame according to the actual output end grayscale value of the pixel of the previous output frame and the output grayscale value of the pixel of the output frame; and
storing the actual output end grayscale value of the output frame in a memory.

10. A liquid crystal display comprising:
a processor configured to generate an output grayscale value of a pixel of an output frame according to N input grayscale values of the pixels of Y input frames; and
a display unit coupled to the processor, and is configured to display the pixel of the output frame according to at least the output grayscale value of the pixel of the output frame;
wherein N and Y are positive integers, and N is greater than or equal to Y.

11. The liquid crystal display of claim 10, wherein the processor accesses a lookup table according to the N input grayscale values of the Y input frames to obtain the output grayscale value of the pixel of the output frame.

12. The liquid crystal display of claim 10, further comprising a memory coupled to the processor, and is configured to store the lookup table.

13. The liquid crystal display of claim 10, wherein when Y=N:
the processor generates the output grayscale value of the pixel of the output frame according to the N input grayscale values of the pixels of a current input frame and previous Y−1 input frames;
wherein the Y input frames are consecutive frames; and
Y>2.

14. The liquid crystal display of claim 10, wherein when N>Y and a frequency of the output frames is X times a frequency of the Y input frames:
each of the Y input frames comprises X sub frames, wherein an input grayscale value of each sub frame of each input frame is the same as an input grayscale value of the each input frame; and
the processor generates the output grayscale value of the pixel of the output frame according to the N input grayscale values of the pixels from an [(X−1)+ (N−1)]th sub frame prior to a current sub frame to an (X−1)th sub frame prior to the current sub frame;
wherein the Y input frames are continuous frames, and the X sub frames are continuous sub frames; and
X is greater than or equal to 2.

15. The liquid crystal display of claim 10, wherein when Y=2, N=3 and a frequency of the output frames is 2 times a frequency of the Y input frames:
each of the Y input frames comprises 2 sub frames, wherein an input grayscale value of each sub frame of each input frame is the same as an input grayscale value of the each input frame; and
the processor generates the output grayscale value of the pixel of the output frame according to the N input grayscale values of the pixels from a 3rd sub frame prior to a current sub frame to a previous sub frame of the current sub frame;
wherein the Y input frames are continuous frames, and the 2 sub frames are continuous sub frames.

16. The liquid crystal display of claim 10, wherein when Y=2, N=3 and a frequency of the output frames is 3 times a frequency of the Y input frames:
each of the Y input frames comprises 3 sub frames, wherein an input grayscale value of each sub frame of each input frame is the same as an input grayscale value of the each input frame; and
the processor generates the output grayscale value of the pixel of the output frame according to the N input grayscale values of the pixels from a 4th sub frame prior to a current sub frame to a 2nd sub frame prior to the current sub frame;
wherein the Y input frames are continuous frames, and the 3 sub frames are continuous sub frames.

17. The liquid crystal display of claim 10, wherein:
the processor accesses an end grayscale overdrive lookup table to generate the output grayscale value of the pixel of the output frame according to an actual output end grayscale value of a pixel of a previous output frame and a current input grayscale value.

18. The liquid crystal display of claim 17, further comprising:
a memory coupled to the processor, and is configured to store the actual output end grayscale value of the pixel of the previous output frame.

19. The liquid crystal display of claim 17, wherein:
the processor further accesses an end grayscale input lookup table to generate an actual output end grayscale value of the output frame according to the actual output end grayscale value of the pixel of the previous output frame and the current input grayscale value; and
the liquid crystal display further comprises a memory coupled to the processor, and is configured to store the actual output end grayscale value of the output frame.

20. The liquid crystal display of claim 17, wherein:
the processor further accesses an end grayscale output lookup table to generate an actual output end grayscale value of the output frame according to the actual output end grayscale value of the pixel of the previous output frame and the output grayscale value of the pixel of the output frame; and
the liquid crystal display further comprises a memory coupled to the processor, and is configured to store the actual output end grayscale value of the output frame.
